(19) United States
(12) Patent Application Publication
(10) Pub. No.: US 2016/0107616 A1
(43) Pub. Date: Apr. 21, 2016

(54) WINDSCREEN WIPER DEVICE

(71) Applicant: Federal-Mogul Motorparts Corporation, Southfield, MI (US)

(72) Inventors: William D. Young, III, Waterford, MI (US); Dennis E. Cox, Belleville, MI (US)

(21) Appl. No.: 14/885,395

(22) Filed: Oct. 16, 2015

Related U.S. Application Data
(60) Provisional application No. 62/065,340, filed on Oct. 17, 2014.

(51) Int. Cl. B60S 1/40

(52) U.S. Cl. CPC B60S 1/40; B60S 1/4048; B60S 2001/4051

(57) ABSTRACT

The windscreen wiper device has a carrier element which operably supports and biases a wiper blade. A two-piece connecting device is provided and includes a base and a joint part. The base is secured with the carrier element and/or the wiper blade. The joint part is pivotally attached with the base and has a main body portion which extends between opposite longitudinal ends and a front nose portion which is connected with one of the longitudinal ends. The joint part further includes a pair of rear locking lugs which extend from the other longitudinal end. The main body portion has a top surface with a resilient tab formed therein, and the resilient tab has a button with a stepped surface that faces longitudinally towards the front nose portion and presents three vertically and longitudinally spaced tiers for lockingly connecting the joint part with differently sized oscillating arms.

### CROSS REFERENCE TO RELATED APPLICATION

This patent application claims the benefit of and priority to U.S. Provisional Patent Application Ser. No. 62/065,340 filed Oct. 17, 2014, the entire disclosure of the application being considered part of the disclosure of this application, and hereby incorporated by reference.

### BACKGROUND OF THE INVENTION

1. Technical Field

This invention relates generally windscreen wiper devices and more particularly to connecting devices for attaching windscreen wiper devices to oscillating wiper arms.

2. Related Art

Passenger vehicles are provided with any one of a range of different styles of oscillating wiper arms including, for example, various sizes of pin-style wiper arms, bayonet-style wiper arms, and top lock-style wiper arms. These oscillating arms are of such different shapes and configurations that they must be secured with windscreen wiper devices in very different manners. This leads to increased manufacturing costs since the windscreen wiper device must design and test differently configured connecting devices for attachment with the various shapes and sizes of oscillating arms.

Other windscreen wiper devices include connecting devices with a single base and multiple joint parts which are each configured for attachment with different sizes and styles of oscillating arms. The joint part attached to the base must be chosen depending upon which type of oscillating arm the windscreen wiper device is to be attached.

### SUMMARY OF THE INVENTION AND ADVANTAGES

One aspect of the present invention provides for a windscreen wiper device. The windscreen wiper device includes a longitudinally extending wiper blade of a flexible material for sealing against a windshield. The carrier element operably supports the wiper blade and operably biases the wiper blade into a pre-curved shape. A two-piece connecting device is provided for attachment with a wiper arm. The connecting device includes a base which is secured with at least one of the carrier element and the wiper blade. The connecting device further includes a joint part which is pivotally attached with the base and is made as a single integral piece. The joint part has a main body portion which extends between opposite longitudinal ends and a front nose portion which is connected with one longitudinal end of the main body portion via a living hinge for allowing the front nose portion to pivot relative to the main body portion. The joint part further includes a pair of rear locking lugs which extend from the longitudinal end of the main body portion opposite of the front nose portion. The main body portion of the joint part has a top surface with a resilient tab formed therein. The resilient tab has a button with a stepped surface that faces longitudinally towards the front nose portion and presents three vertically and longitudinally spaced tiers for lockingly connecting the joint part with differently sized oscillating arms.

The windscreen wiper device is advantageous for both original equipment and aftermarket applications. For original equipment applications, the windscreen wiper device allows for manufacturing cost savings by allowing the windscreen wiper device manufacturer to utilize a single connecting device with a range of different styles and sizes of oscillating arms. These same manufacturing cost savings also apply in the aftermarket, but in the aftermarket, packaging cost savings are also realized because the windscreen wiper blade manufacturer can sell the same product in the same package for a range of vehicles with different styles and sizes of oscillating wiper arms.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a perspective and partially exploded view of an exemplary embodiment of a windscreen wiper device;

FIG. 2 is a cross-sectional view of the windscreen wiper device taken along Line 2-2 of FIG. 1;

FIG. 3 is an exploded view of a connecting device of the windscreen wiper device of FIG. 1;

FIG. 4 is a perspective view of a joint part of the connecting device of FIG. 3;

FIG. 5 is an enlarged view of a portion of the joint part of FIG. 4;

FIG. 6 is a top elevation view of the joint part of FIG. 4;

FIG. 7 is an elevation view showing connecting device of FIG. 3 in connection with a side pin-style oscillating arm;

FIG. 8 is a side and fragmentary view showing the joint part of FIG. 4 during a process of attaching the joint part with a top lock style oscillating arm or a top lock with window style oscillating arm;

FIG. 9 is an enlarged view of a portion of FIG. 8;

FIG. 10 is a perspective and fragmentary view of a top lock with window style oscillating arm in connection with the connecting device of FIG. 3;

FIG. 11 is a perspective and fragmentary view of a top lock style oscillating arm in connection with the connecting device of FIG. 3;

FIG. 12 is a perspective and fragmentary view of a 22 mm bayonet-style oscillating arm in connection with the connecting device of FIG. 3; and

FIG. 13 is a perspective and fragmentary view of a 19 mm bayonet-style oscillating arm in connection with the connecting device of FIG. 3.

### DETAILED DESCRIPTION OF PRESENTLY PREFERRED EMBODIMENTS

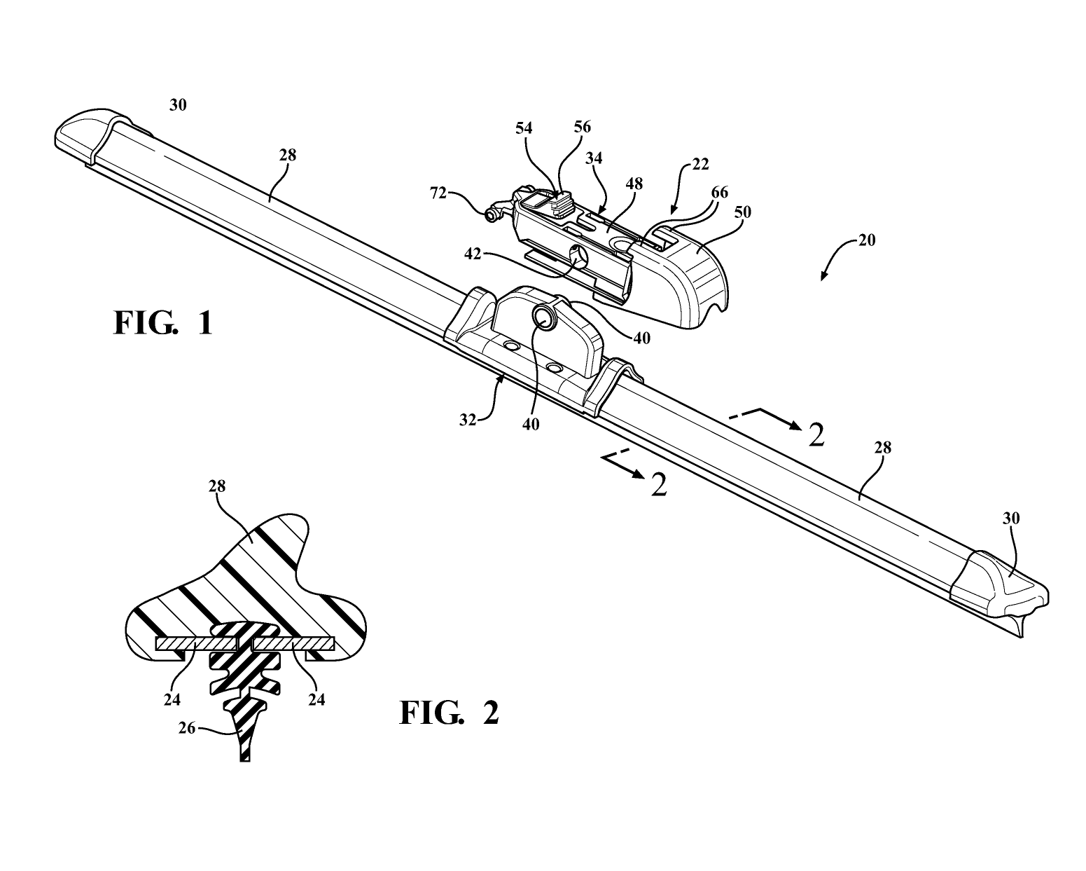

Referring to the Figures, wherein like numerals indicate corresponding parts throughout the several views, an exemplary embodiment of a windscreen wiper device 20 with a connecting device 22 that is configured for attachment with a range of different sizes and styles of oscillating wiper arms is generally shown in FIG. 1. Specifically, the connecting device 22 is adapted for attachment with the following styles and sizes of oscillating wiper arms: 19 mm bayonet-style, 22 mm bayonet-style, 19 mm pin-style, 22 mm pin-style, top lock-style and top lock with window-style. The connecting device 22 is configured for attachment with any of these different sizes and styles of wiper arms without any add-on or interchangeable parts, which allows for manufacturing cost savings for original equipment applications through economies of scale. As shown in FIGS. 1 and 2, the exemplary windscreen wiper device 20 is a beam-style wiper device in that it includes a longitudinally extending carrier element 24 which biases a wiper blade 26 (sometimes also known as a wiper strip or a wiper element) of a flexible material (for example, rubber) into a pre-curved shape maintaining a fluid-tight seal along the longitudinal length of the wiper blade against a curved windshield as the windscreen wiper device 20 oscillates back and forth on the curved windshield. The windscreen wiper device 20 also has a pair of subspoilers 28 which are disposed on opposite longitudinal sides of the connecting device 22 and which extend between the connecting device 22 and respective end caps 30 for applying a downforce on the wiper blade to improve the seal between the wiper blade 26 and the windshield when the vehicle is travelling at speed.

Referring now to FIG. 1, the connecting device 22 is composed of two pieces including a base 32 piece and a joint part 34 piece. The base 32 and the joint part 34 are each preferably made of single pieces of injection molded plastic. Subsequently, the base 32 and joint part 34 are pivotally joined together to allow the joint part 34 to pivot relative to the base 32 about a pivot axis. The base 32 is preferably secured in a non-removable manner to the carrier element 24 (shown in FIG. 2) and/or to the wiper blade 26.

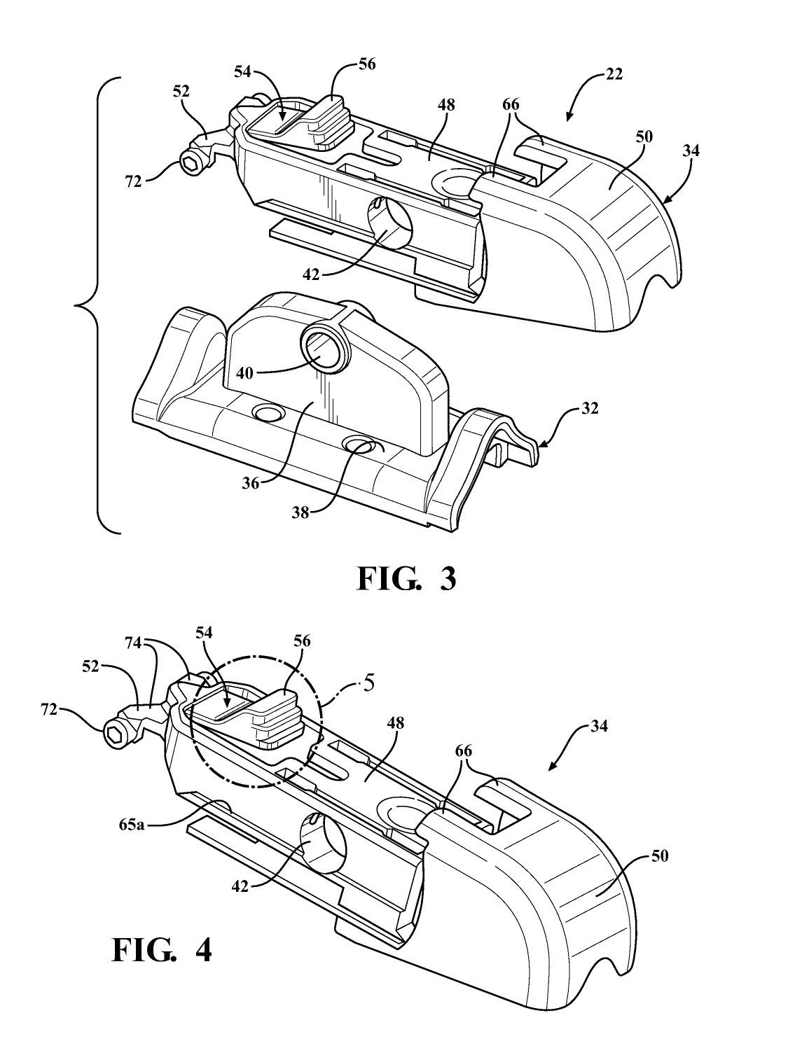

As shown in FIG. 3, the base 32 includes a pair of laterally spaced and vertically extending walls 36 which extend upwardly from a bottom surface 38, and each of the vertical walls 36 has a protrusion 40 which projects laterally therefrom. The protrusions 40 are both generally circular in shape, extend in opposite lateral directions and are aligned with one another. The protrusions 40 of the exemplary embodiment are generally tubular in shape and have coaxial through holes such that each protrusion 40 has an outer bearing surface and an inner bearing surface. The joint part 34 is provided with a pair of coaxial openings 42 which are shaped similarly to the protrusions 40 for receiving the protrusions 40 to establish the pivotal connection between the joint part 34 and the base 32. The coaxial through holes of the protrusions 40 and the coaxial openings 42 on the joint part 34 allow the connecting device 22 to be mated with a side-pin style wiper arm 44 by inserting a pin (not shown) through the co-axial through holes. When the side-pin style wiper arm 44 is properly connected with the connecting device 22, a flange on the wiper arm 44 wraps around the joint part 34 to prevent unintentional detachment of the connecting device 22 from the wiper arm 44. Although not shown, it should be appreciated that the joint part could alternately be formed with only one opening for receiving one of the protrusions and with a recess for receiving the other protrusion to establish the pivotal connection between the base and the joint part.

Referring now to FIG. 4, the exemplary embodiment of the joint part 34 is divided longitudinally into three portions: a main body portion 48, a front nose portion 50 and a rear lug portion 52. The main body portion 48 is generally U-shaped when viewed in cross-section and presents a top wall and a pair of laterally spaced sidewalls, and the aforementioned openings are located on the sidewalls.

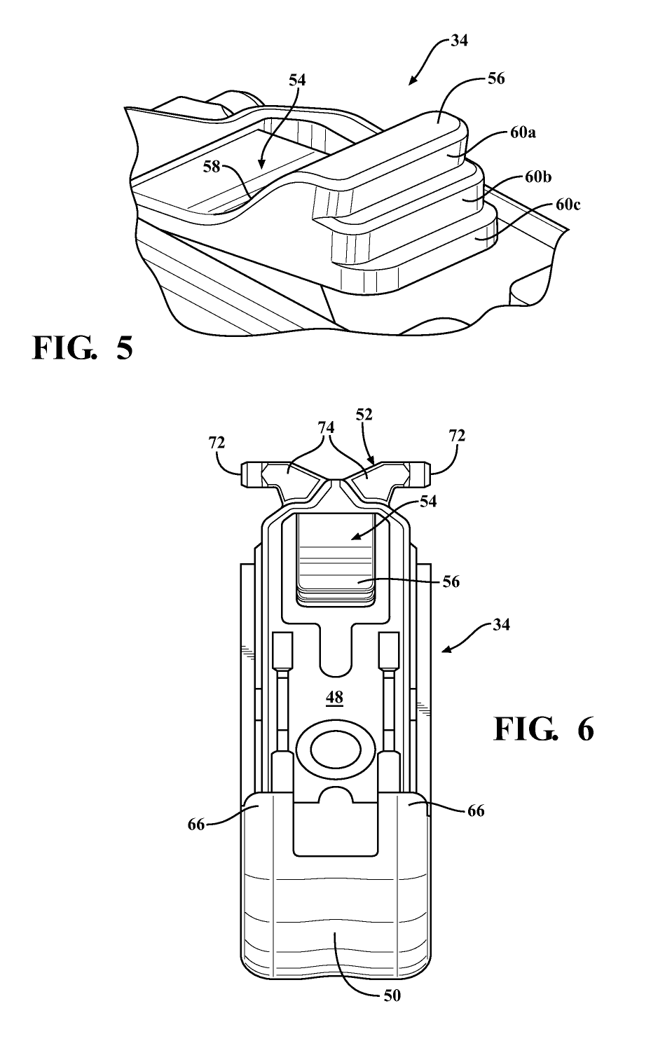

As shown in FIG. 6, the top wall of the main body portion 48 includes a resilient, or spring loaded tongue 54 which is integrally connected with the top wall at a first living hinge which is positioned adjacent the rear lug portion 52 of the joint part 34. The tongue 54 extends longitudinally from the first living hinge towards the pivot axis and the front nose portion 50. The tongue 54 includes a button 56 which is spaced from the integral hinge adjacent a front edge of the tongue 54 and which projects vertically upwardly for engaging within correspondingly shaped windows in the bayonet-style and top lock with window-style wiper arms. As shown in FIG. 5, the tongue 54 has a back surface 58 which faces away from the pivot axis and which is ramped for facilitating the connection of the joint part 54 with the bayonet-style wiper arms. Specifically, the ramped back surface 58 of the button 56 causes the tongue 54 to resiliently flex downwardly at the first living hinge when a front edge the bayonet-style wiper arm makes contact with the ramped back surface 58. The button 56 automatically springs outwardly into its resting position when it encounters the window in the respective bayonet-style wiper arm.

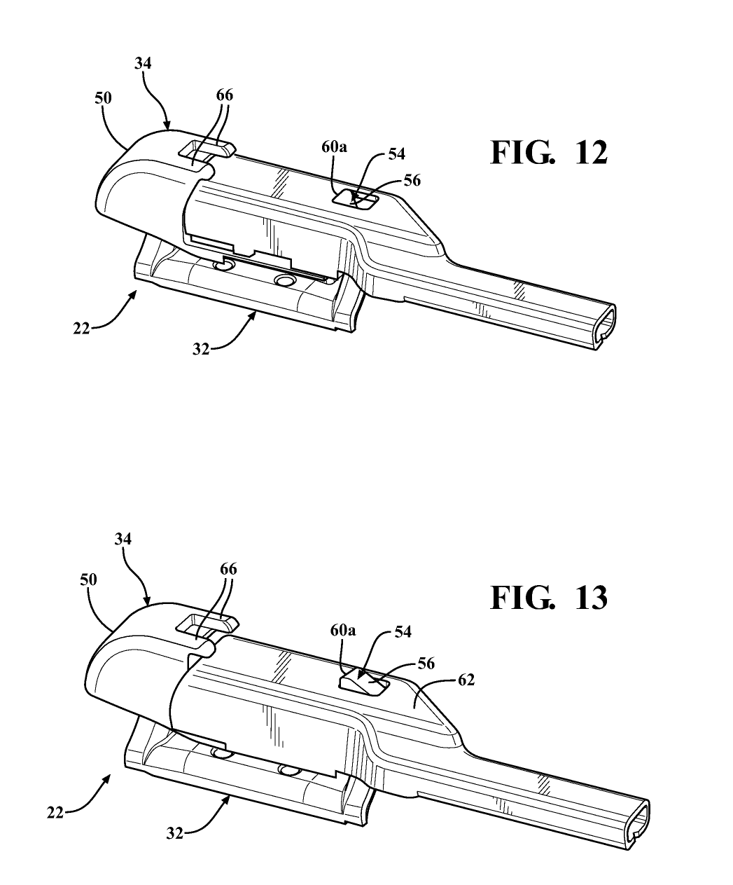

Referring still to FIG. 5, the front surface of the button 56 is stepped to present three distinct vertically and longitudinally spaced tiers 60a, 60b, 60c which are shaped like steps and which face towards the pivot axis. Two of the three tiers 60a, 60b, 60c are specifically positioned relative to one another and to the front nose portion 52 of the joint part 34 for engaging with a front edges of the windows of differently sized bayonet-style wiper arms. Specifically, as shown in FIG. 12, the top tier 60a of the button 56 is configured for engaging with the window of the 19 mm bayonet-style wiper arm 62. The middle tier 60b of the button 56 is positioned for engaging with the window of the 22 mm bayonet-style wiper arm 62, as shown in FIG. 13, and the bottom tier 60c (shown in FIG. 5) is positioned to function as a secondary stop for the window of the 22 mm bayonet style wiper arm 64. In other words, the bottom tier 60c is a backup safety feature to prevent unintentional detachment of the wiper device from the 22 mm bayonet-style wiper arm 64.

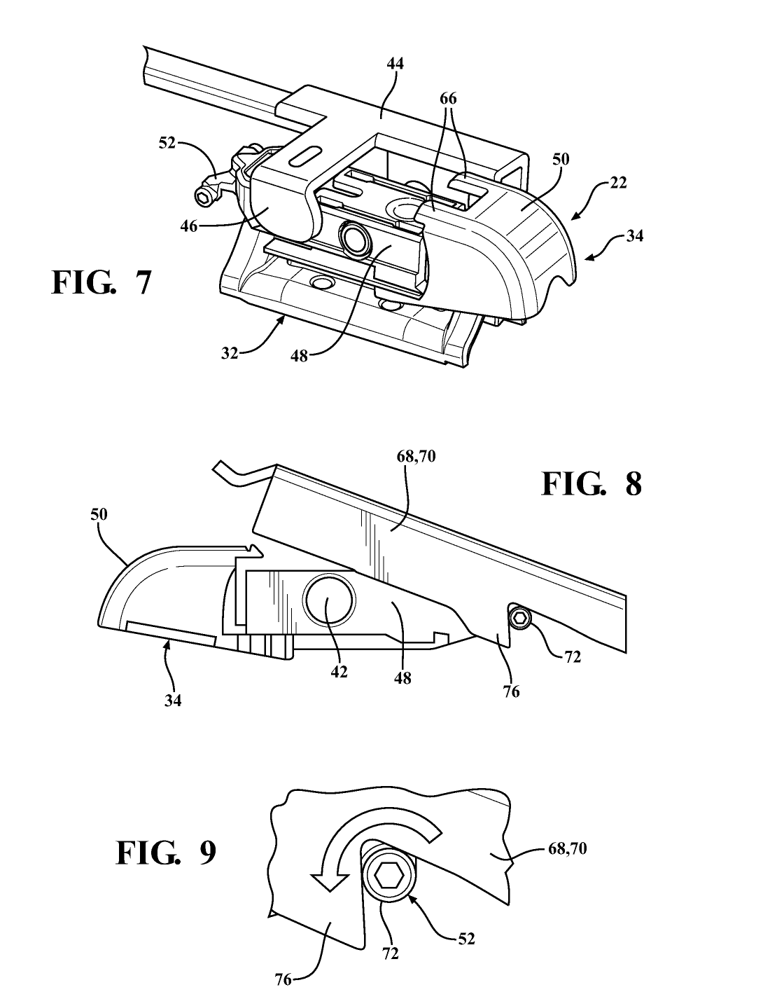

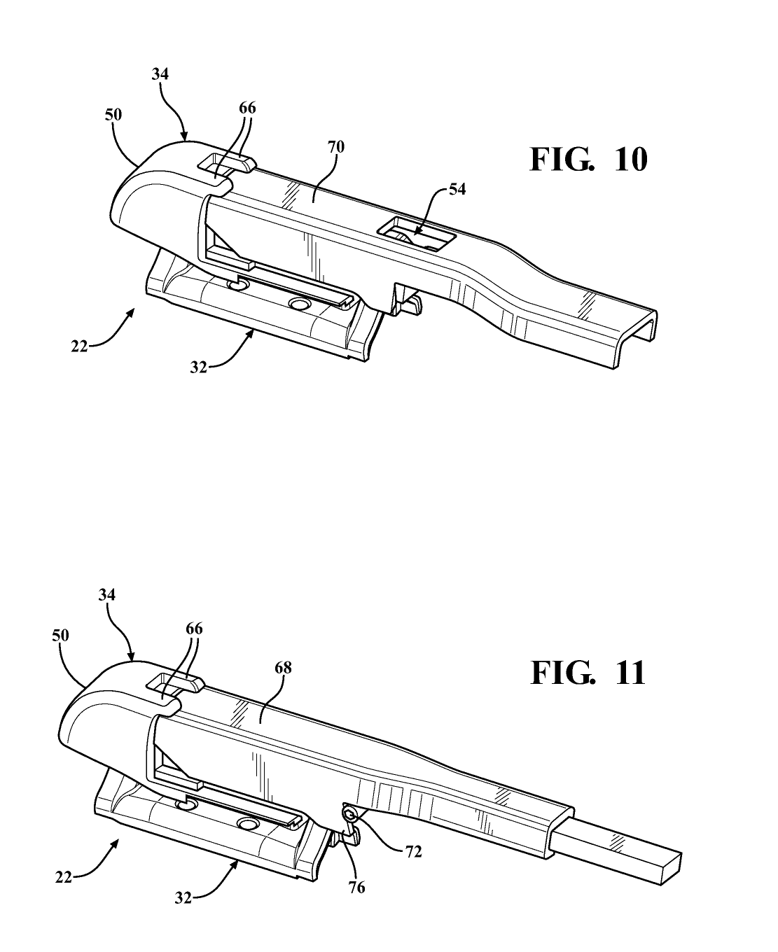

Referring back to FIG. 4, at the lower ends of the sidewalls of the main body portion 48, the joint part includes a pair of vertically spaced rails 65a, 65b which extend laterally outwardly. The lower rail 65b is configured to engage with a lower flange of the 22 mm bayonet-style wiper arm 62 (as shown in FIG. 13), and the upper rail 65a is configured to engage with a lower flange of a 19 mm bayonet-style wiper arm (as shown in FIG. 7). Additionally, the upper rail 65a is positioned for supporting a lower edge of the top lock with window and top lock-style wiper arms 68, 66, as shown in FIGS. 10 and 11 respectively.

The 19 mm bayonet-style wiper arm 62 and the 22 mm bayonet-style wiper arm 64 may be detached from the joint part 34 by pressing the button 56 downwardly through the window in the respective wiper arm 62, 64 and sliding the windscreen wiper device 20 away from the wiper arm 62, 64.

The front nose portion 50 of the joint part 34 is located at one longitudinal end of the main body portion 48 and is spaced longitudinally from the pivot axis. The front nose portion 50 includes a pair of fingers 66 which extend longitudinally from an upper surface of the front nose portion 50 for releasably engaging with a front edge of top lock-style 68 (shown in FIG. 11) and top lock with window-style wiper arms 70 (shown in FIG. 10). The front nose portion 50 is connected to the main body portion 48 at a lower end of the front nose portion 50 via a second living hinge which allows the front nose portion 50 to flex forwardly and backwardly for releasably locking the fingers 66 with the top surface of the respective wiper arm. The front nose portion 50 also includes a U-shaped recess between the fingers 66 for allowing passage of a projection that extends forwardly from the front edges of the top lock-style and top lock with window-style wiper arms 68, 70.

Referring now to FIG. 4, the rear lug portion 52 of the joint part 34 includes a pair of generally cylindrical lugs 72 which are spaced longitudinally from the back end of the main body portion 48 and extend away from one another in opposite lateral directions. The cylindrical lugs 72 are solidly (i.e., non-resiliently) connected with the main body portion 48 via bridge sections 74 which are integrally connected with the main body portion 48.

Referring now to FIGS. 8-11, connecting the joint part 34 with either the top lock-style wiper arm 68 or the top lock with window-style wiper arm 70 involves angling the joint part 34 and the respective wiper arm 68, 70 relative to one another. Next, the cylindrical lugs 72 on the joint part 34 are engaged with back legs 76 of the respective wiper arm. Then, the joint part 34 and wiper arm 68, 70 are pivoted relative to one another about the cylindrical lugs 72 until the fingers 66 on the front nose portion 50 spring into a locking engagement with a front edge of the wiper arm 68, 70. The round outer surfaces of the cylindrical lugs 72 smoothen the pivoting of the wiper arm 68, 70 and joint part 34 relative to one another during this connection process.

Disconnecting the top lock-style wiper arm 68 or the top lock with window-style wiper arm 70 from the joint part 34 involves urging the front nose portion 50 forwardly to disengage the fingers 66 on the front nose portion 50 from the wiper arm 68, 70. The joint part 34 and wiper arm 68, 70 may then be pivoted relative to one another in the reverse direction from the installation. During both the installation and the detachment processes, the cylindrical lugs 72 remain in their respective positions and do not resiliently move.

Obviously, many modifications and variations of the present invention are possible in light of the above teachings. It is, therefore, to be understood that within the scope of the appended claims, the invention may be practiced otherwise than as specifically described.

What is claimed is:

1. A windscreen wiper device, comprising:
a longitudinally extending wiper blade of a flexible material for sealing against a windshield;
a carrier element operably supporting said wiper blade and operatively biasing said wiper blade into a pre-curved shape;
a two-piece connecting device including a base and an joint part for attachment with an oscillating wiper arm;
said base which is secured with at least one of said carrier element and said wiper blade;
said joint part being which is pivotally attached with said base and being of a single integral piece;
said joint part including a main body portion extending between opposite longitudinal ends and a front nose portion connected with one longitudinal end of said main body portion via a living hinge for allowing said front nose portion to pivot relative to said main body portion and a pair of rear locking lugs extending from said longitudinal end of said main body portion opposite of said front nose portion;
said main body portion of said joint part having a top surface with a resilient tab formed therein and said resilient tab having a button with a stepped surface facing longitudinally towards said front nose portion of said joint part and presenting three vertically and longitudinally spaced tiers for lockingly connecting said joint part with differently sized wiper arms.

2. The windscreen wiper device as set forth in claim 1 wherein said rear locking lugs of said joint part are generally cylindrical in shape.

3. The windscreen wiper device as we forth in claim 1 wherein said base has a pair of protrusions and wherein said main body portion of said joint part has a pair of laterally spaced apart sidewalls and wherein said sidewalls have coaxial openings which receive said protrusions to allow said joint part to pivot relative to said base.

4. The windscreen wiper device as set forth in claim 3 wherein at least one of said protrusions on said base has a through hole for receiving a side pin of a pin-style wiper arm.

5. The windscreen wiper device as set forth in claim 3 wherein said front nose portion includes a pair of locking fingers which extend longitudinally towards said main body portion for lockingly engaging an upper surface of an oscillating wiper arm.

6. The windscreen wiper device as set forth in claim 5 wherein said locking fingers on said front nose portion are spaced laterally from one another on opposite sides of a U-shaped slot which faces towards said main body portion of said joint part.

7. The windscreen wiper device as set forth in claim 1 wherein said resilient tab is interconnected with said top surface of said main body portion adjacent said rear locking lugs.

8. The windscreen wiper device as set forth in claim 1 wherein said button has a ramped surface on an opposite side of said three tiers.

9. The windscreen wiper device as set forth in claim 1 wherein said base and joint part are each made of single integral pieces.
